(19) United States
(12) Patent Application Publication
(10) Pub. No.: US 2023/0137276 A1
(43) Pub. Date: May 4, 2023

(54) TEXTILE PRINTING WITH SILICONE PRETREAT COMPOSITIONS

(71) Applicant: HEWLETT-PACKARD DEVELOPMENT COMPANY, L.P., Spring, TX (US)

(72) Inventors: Dennis Z. Guo, San Diego, CA (US); Jie Zheng, San Diego, CA (US)

(21) Appl. No.: 17/915,890

(22) PCT Filed: Jun. 5, 2020
(86) PCT No.: PCT/US2020/036242

§ 371 Date: Sep. 29, 2022

(51) Int. Cl. D06P 1/44; D06P 1/52; C09D 11/322; C09D 11/102; C09D 11/54; C09D 183/08; D06P 5/00

(52) U.S. Cl. CPC D06P 1/445; D06P 1/5242; D06P 1/5285; C09D 11/322; C09D 11/102; C09D 11/54; C09D 183/08; D06P 5/002

(57) ABSTRACT

The present disclosure describes fluid sets for printing, methods of textile printing, and textile printing systems. In one example, a fluid set for printing can include a pretreat composition, a fixer composition, and a white ink composition. The pretreat composition can include water and an emulsion of a silicone polymer having amino groups. The fixer composition can include a liquid vehicle and a cationic polymer. The white ink composition can include a liquid vehicle, a white pigment dispersion, and a polymeric binder.

### BACKGROUND

Inkjet printing has become a popular way of recording images on various media. Some of the reasons include low printer noise, variable content recording, capability of high speed recording, and multi-color recording. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF DRAWINGS

FIG. 1 is a schematic diagram of an example fluid set in accordance with examples of the present disclosure.

FIG. 2 is a flowchart of an example method of textile printing in accordance with examples of the present disclosure.

FIG. 3 is a schematic diagram of an example textile printing system in accordance with examples of the present disclosure.

FIG. 4 is a schematic diagram of another example textile printing system in accordance with examples of the present disclosure.

### DETAILED DESCRIPTION

The present technology relates to fluid sets, methods, and systems for textile printing. In particular, the present disclosure describes a fluid set for printing on textile fabrics. In one example, a fluid set for printing includes a pretreat composition, a fixer composition, and a white ink composition. The pretreat composition includes water and an emulsion of a silicone polymer having amino groups. The fixer composition includes a liquid vehicle and a cationic polymer. The white ink composition includes a liquid vehicle, a white pigment dispersion, and a polymeric binder. In some examples, the silicone polymer can include a hydroxyl group or a methoxy group attached to a terminal silicon atom of the silicone polymer. In other examples, the silicone polymer can include methyl groups attached to silicon atoms of the silicone polymer, where some of the methyl groups are substituted by C1-C6 aminoalkyl radicals. In certain examples, the aminoalkyl radicals can include an N-(2-aminoethyl)-3-aminopropyl radical, an aminopropyl radical, or a combination thereof. In certain examples, the emulsion of the silicone polymer can have an average particle size from 1 nm to 50 nm. In another example, the pretreat composition can include the silicone polymer in an amount from 1 wt % to 15 wt %. In further examples, the cationic polymer can be curable by forming crosslinking at a curing temperature from 80° C. to 200° C. In still further examples, the white pigment dispersion can include titanium dioxide, zinc oxide, zinc sulfide, antimony oxide, zirconium dioxide, alumina hydrate, or a combination thereof. In a certain example, the polymeric binder can include a polyester polyurethane or an acrylic latex binder.

The present disclosure also describes methods of textile printing. In one example, a method of textile printing includes applying a pretreat composition onto a fabric substrate, wherein the pretreat composition includes water and an emulsion of a silicone polymer having amino groups. The fabric substrate with the pretreat composition applied thereon is heat pressed. A fixer composition is ejected onto the fabric substrate, wherein the fixer composition includes a liquid vehicle and a cationic polymer. A white ink composition is also ejected onto the fabric substrate, wherein the white ink composition includes a liquid vehicle, a white pigment dispersion, and a polymeric binder. The fixer composition and the white ink composition are cured by heating the fabric substrate. In some examples, the curing can be performed at a temperature from 80° C. to 200° C. In further examples, the pretreat composition can be applied by spraying or by ejecting from jetting architecture.

The present disclosure also describes textile printing systems. In one example, a textile printing system includes a fabric substrate, a pretreat composition to be applied to the fabric substrate, a fixer composition to be applied to the fabric substrate, and a white ink composition to be applied to the fabric substrate. The pretreat composition includes water and an emulsion of a silicone polymer having amino groups. The fixer composition includes a liquid vehicle and a cationic polymer. The white ink composition includes a liquid vehicle, a white pigment dispersion, and a polymeric binder. In further examples, the silicone polymer can include a hydroxyl group or a methoxy group attached to a terminal silicon atom of the silicone polymer and a plurality of methyl groups attached to silicon atoms of the silicone polymer, wherein some of the methyl groups are substituted by C1-C6 aminoalkyl radicals. In certain examples, the aminoalkyl radicals can include an N-(2-aminoethyl)-3-aminopropyl radical, an aminopropyl radical, or a combination thereof.

As a note, with respect to the ink compositions, fluid sets, methods, and systems for textile printing described herein, more specific descriptions can be considered applicable to other examples whether or not they are explicitly discussed in the context of that example. Thus, for example, in discussing a pigment related to the ink composition, such disclosure is also relevant to and directly supported in context of the fluid sets and the methods of textile printing, and vice versa.

### Fluid Sets for Printing

As mentioned above, the fluid sets described herein can include a pretreat composition, a fixer composition, and a white ink composition. The fluid sets can be used to print white images and patterns, in particular on fabric substrates. Washfastness, or the ability of printed ink to retain its color after washing the fabric, is one consideration involved in textile printing. To achieve good washfastness with pigmented ink, the printed ink is often cured at a high temperature after printing to increase the durability of the printed image. However, the high temperatures used during curing, such as 150° C. or higher, can tend to increase migration of colored dye from the fabric substrate into the printed ink when printing on dyed synthetic fabrics. Therefore, when a white ink is printed on a dyed synthetic fabric substrate and subsequently cured at a high temperature, the colored dye from the fabric can affect the color of the white ink. The result can be an off-white color that has an obvious shade of the underlying dye color. In some examples, dye migration can be particularly pronounced when the fabric substrate is a dyed polyester or polyester blend fabric.

Some analog methods of printing on colored polyester, such as screen printing, include applying a dye blocker to dyed fabric before printing pigmented ink on the fabric. A dye blocker prevents dye migration from colored polyester into the printed image during the curing typically at 150° C. or higher. However, dye blockers used in analog printing are often unsuitable for digital printing because the dye blockers can be pastes or have a very high viscosity, which can make the dye blockers unusable in digital printing processes. Another way to mitigate this dye migration issue is to cure the printed images at a lower temperature, e.g., <130° C., at which dye migration is reduced. However, printed images cured at lower temperature can have poor durability such as washfastness.

The fluid sets described herein can be used to print white ink on fabric substrates with good durability and good opacity. When printing on colored fabric with 100% cotton, the white images can be cured at 80° C. to 200° C. When printing on colored polyester fabric, the white images can be cured at 80° C. to 130° C. The white ink can retain its whiteness because dye migration from the polyester fabric is reduced when cured at a lower temperature. The printed images with the said fluid set cured at a lower temperature also have excellent durability such as washfastness. If a white image is cured at a temperature over 130° C., dye migration can become visible and the image quality may not be satisfactory.

The fluid sets can include a pretreat composition including water and an emulsion of a silicone polymer having amino groups. This pretreat composition can be applied to a fabric substrate before printing the white ink. This pretreat composition reduces white ink penetration into fabrics and increases white opacity. In some cases, the pretreat composition can be applied and then the fabric substrate can be heated to dry and cure the pretreat composition. The fluid sets can also include a fixer composition and a white ink composition. In various examples, the fixer composition can be applied before or after the white ink composition. In some examples, the fixer composition can include a liquid vehicle and a cationic polymer. The white ink composition can include a liquid vehicle, a white pigment dispersion, and a polymeric binder. The fixer composition and the white ink composition printed on the pretreated fabric substrate can provide a durable white image with good washfastness and good opacity after it is cured.

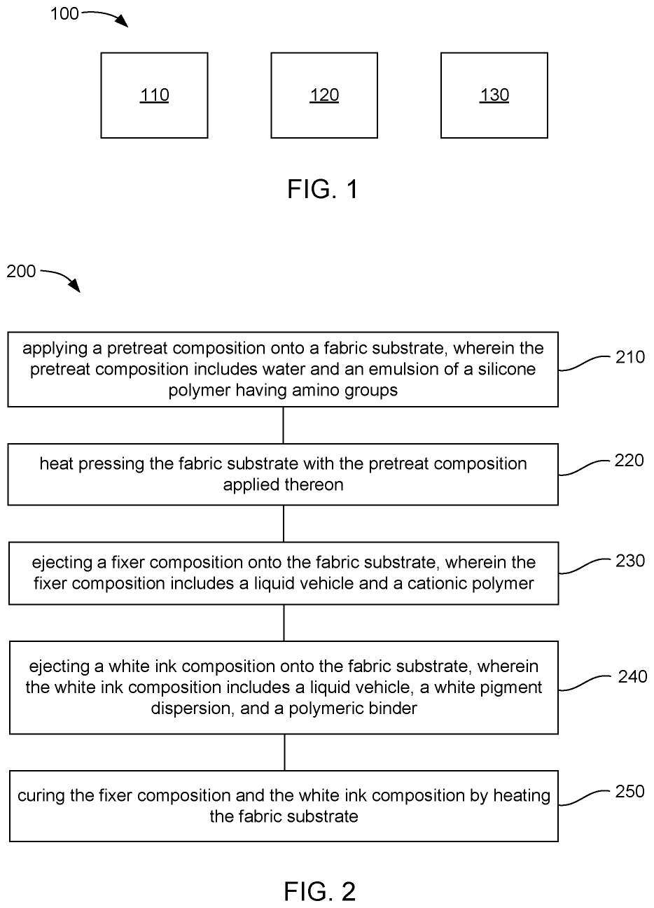

FIG. 1 shows a schematic representation of an example fluid set 100. This fluid set includes a pretreat composition 110, a fixer composition 120, and a white ink composition 130. In this example, the pretreat composition includes water and an emulsion of a silicone polymer having amino groups. The fixer composition includes a liquid vehicle and a cationic polymer. The white ink composition includes a liquid vehicle, a white pigment dispersion, and a polymeric binder.

In some examples, the pretreat composition can be applied before the fixer composition and the white ink. The pretreat composition can include an emulsion of a silicone polymer that can increase the hydrophobicity of the fabric surface when cured, which helps enhance opacity by reducing penetration of the white ink into the fabric. The silicone polymer can include a polymer chain made up of silicon and oxygen atoms. For example, the silicone polymer can include a polysiloxane backbone made up of alternating silicon and oxygen atoms. Additionally, the polymer can include a plurality of methyl groups attached to silicon atoms of the polysiloxane backbone, where some of the methyl groups are substituted by C1-C6 aminoalkyl radicals. Examples of the amino C1-C6 alkyl radical can include N-(2-aminoethyl)-3-aminopropyl and aminopropyl radicals.

In certain examples, the silicone polymer of the pretreat composition can include a polysiloxane backbone with a hydroxyl group or a methoxy group attached to terminal silicon atoms of the polysiloxane backbone. For example, both terminal silicon atoms of the polysiloxane backbone can be attached to either a methoxy or hydroxy group. Or, in another example, one terminal silicon atom of the polysiloxane can be attached to a methoxy group and the other terminal silicon atom can be attached to a hydroxyl group.

Some examples of the silicone polymer can have a chemical structure according to scheme (I) shown below:

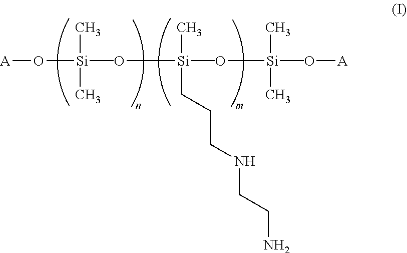

In scheme (I), A can be either —CH₃ or —H; n is the number of dimethyl siloxane monomer units in the silicone polymer, and m is the number of methyl N-(2-aminoethyl)-3-aminopropyl siloxane monomer units. In some examples, n and m can independently be integers such that the molecular weight (Mw) of the polymer is from about 1,000 Mw to about 300,000 Mw. The number of amino groups can be sufficient such that the polymer includes about 0.1 meq/gram or more of the amino groups.

In further examples, the silicone polymer can have a chemical structure according to scheme (II) shown below:

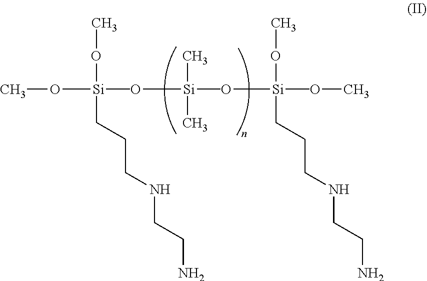

In scheme (II), n can be an integer such that the molecular weight (Mw) of the polymer is from about 1,000 Mw to about 300,000 Mw.

The silicone polymer can be prepared as an emulsion in water in some examples. In certain examples, the emulsion can have an average particle size from 1 nm to 50 nm, or from 3 nm to 30 nm or, from 5 nm to 25, or from 10 nm to 20 nm. In some cases, the emulsion can include an emulsifying agent such as a surfactant. In other examples, the emulsion can be free of surfactants. Non-limiting examples of silicone emulsions that can be used can include WACKER® HC 303 available from Wacker (Germany), ICM EM 1612 and 1616 available from CHT (Germany), and HANSA CARE® 7140 available from CHT (Germany).

The pretreat composition can be dried and cured after applying to a fabric substrate to form a dry layer of the silicone polymer. In some examples, heat can be used to dry and cure the silicone polymer. For example, the fabric substrate can be heat pressed after the pretreat composition is applied. In certain examples, the silicone polymer can be dried and/or cured by heat pressing the fabric substrate at a temperature from 80° C. to 180° C. In a specific example, the fabric substrate can be heat pressed at a temperature from 100° C. to 120° C. for a time of 30 seconds to 2 minutes or from 1 minute to 2 minutes. In another specific example, the fabric substrate can be heat pressed at a temperature from 120° C. to 150° C. for a time from 30 seconds to 90 seconds or from 30 seconds to 60 seconds.

In some examples, the silicone emulsion can be diluted in water or an aqueous vehicle. In certain examples, the amount of the silicone polymer in the pretreat composition can be from 1 wt % to 15 wt % by dry weight of the silicone polymer out of the total weight of the pretreat composition. In further examples, the amount of silicone polymer can be from 2 wt % to 10 wt % or from 3 wt % to 8 wt %.

The pretreat composition can be applied by analog application methods or by digital application methods, in various examples. When applied using an analog method, the silicone emulsion can be applied as-is or diluted to an appropriate concentration in water. Analog methods of application can include spraying, padding, roll-on and other coating methods. When applied using a digital method such as inkjet printing, the pretreat composition can include an aqueous vehicle that is formulated to be jettable. In either case, the pretreat composition can include additives in addition to the silicone polymer and water.

The aqueous liquid vehicle used in the pretreat composition can include water and various additives. In some examples, the aqueous vehicle can include a water content of from 50 wt % to 99 wt % or from 60 wt % to 85 wt %, as well as organic co-solvent, e.g., from 1 wt % to 25 wt %, from 2 wt % to 20 wt %, or from 4 wt % to 15 wt %. Other liquid vehicle components can also be included, such as antibacterial agent, etc. In further detail regarding the liquid vehicle, co-solvent(s) can be present and can include any co-solvent or combination of co-solvents that are compatible with the silicone emulsion and other ingredients in the pretreat composition. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The pH of the pretreat composition is from 3 to 6, 3.5 to 5.5 or 4 to 5. pH the pretreat composition can be used with an acid to a desirable target. Examples of acids for pH adjustment include acetic acid, glycolic acid, citric acid, hydrochloric acid, sulfuric acid and phosphoric acid.

Consistent with the formulations of the present disclosure, various other additives may be included to provide desired properties of the pretreat composition for specific applications. Examples of these additives are those added to inhibit the growth of harmful microorganisms. These additives may be biocides, fungicides, and other microbial agents, which are routinely used in these types of formulations. Examples of suitable microbial agents include, but are not limited to, ACTICIDE®, e.g., ACTICIDE® B20 (Thor Specialties Inc.), NUOSEPT™ (Nudex, Inc.), UCARCIDE™ (Union carbide Corp.), VANCIDE® (R.T. Vanderbilt Co.), PROXEL™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH. Viscosity modifiers and buffers may also be present, as well as other additives to modify properties of the pretreat composition as desired.

In a particular example, the pretreat composition can include the silicone polymer emulsion in an amount from 1 wt % to 15 wt %, organic co-solvent in an amount from 1 wt % to 20 wt %, surfactant in an amount from 0.1 wt % to 5 wt %, and water.

Turning now to the fixer composition, in some examples the fixer composition can be applied by digital methods such as inkjet printing. Accordingly, the fixer composition can also include a liquid vehicle formulated to be jettable. In some examples, the fixer composition can include any of the same liquid vehicle ingredients described above with respect to the liquid vehicle of the pretreat composition. In particular examples, the fixer liquid vehicle can include water, organic co-solvent, and other additives.

The fixer composition can also include a cationic polymer. In some examples, the cationic polymer can be capable of crosslinking a polymeric binder present in the white ink composition or the functional group on the fabric surface. Therefore, the fixer composition can crosslink the polymeric binder in the white ink composition after curing. This can increase the durability of the white image printed on the fabric. The cationic polymer can also crash the negatively charged white pigment dispersion to increase opacity. In some examples, the fixer composition can be applied onto the fabric substrate before jetting the white ink composition. In other examples, the fixer composition can be applied after or concurrently with the white ink composition.

The cationic polymer included in the fixer composition can have a weight average molecular weight ranging from 3,000 Mw to 3,000,000 Mw. Any weight average molecular weight (Mw) throughout this disclosure may be expressed as Mw, and is in Daltons. In some examples, the cationic polymer included in the fixer composition can have a weight average molecular weight from 3,000 Mw to 200,000, or from 3,000 Mw to 100,000 Mw, or from 3,000 Mw to 50,000 Mw, for example. This molecular weight may provide for the cationic polymer to be printed by thermal inkjet printheads with good print reliability in many instances. When using other technology to eject the fixer composition, higher molecular weights may be useable, such as from 200,000 Mw to 3,000,000 Mw, e.g., applied by piezoelectric printheads and/or analog methods.

Examples of the cationic polymer include poly(diallyldimethylammonium chloride); or poly(methylene-co-guanidine) anion with the anion selected from the hydrochloride, bromide, nitrate, sulfate, or sulfonate; a polyamine; poly(dimethylamine-co-epichlorohydrin); a polyethylenimine; a polyamide epichlorohydrin resin; a polyamine epichlorohydrin resin; or a combination thereof. Some examples of commercially available polyamine epichlorohydrin resins may include CREPETROL™ 73, KYMENE™ 736, KYMENE™ 736NA, POLYCUP™ 7360, and POLYCUP™ 7360A, available from Solenis LLC.

The amount of the cationic polymer in the fixer composition can be from 1 wt % to 15 wt % based on the dry weight of the cationic polymer out of the total weight of the fixer composition, in some examples. In further examples, the amount can be from 2 wt % to 10 wt % or from 2 wt % to 5 wt %. The amounts of ingredients included in the liquid vehicle of the fixer composition can be any of the amounts described above for the liquid vehicle of the pretreat composition.

In certain examples, the fixer composition can include a cationic polymer in an amount from 1 wt % to 15 wt %, organic co-solvent in an amount from 1 wt % to 20 wt %, surfactant in an amount from 0.1 wt % to 5 wt %, and water.

The white ink composition can include a liquid vehicle, a white pigment dispersion, a polymeric binder, a surfactant, a biocide and other additives such as a rheology modifier. The white pigment can include pigments such as titanium dioxide, zinc oxide, zinc sulfide, antimony oxide, zirconium dioxide, alumina hydrate, or combinations thereof. In a certain example, the white pigment can be rutile titanium dioxide. In certain examples, the white pigment can be present in the white ink composition in an amount from 1 wt % to 20 wt %, or from 2 wt % to 15 wt %, or from 5 wt % to 15 wt %. The particle size of the white pigment can be suitable for jetting. In some examples, the white pigment can have an average particle size from 100 nm to 800 nm, or from 150 nm to 500 nm, or from 200 nm to 400 nm.

The white pigment can be dispersed by a dispersant, such as a polymer dispersant or any other dispersant technology suitable for suspending the pigment in the liquid vehicle. Example polymer dispersants can include anionic polymers, non-ionic polymers or a combination of both. Examples of anionic dispersants include CARBOSPERSE™ K7028 from Lubrizol (USA), TAMOL™ 731A from Dow Chemicals (USA) and COADIS™ 123 K from Coatex (France). Examples of non-ionic and low ionic dispersants include DISPERBYK® 190, 2012, and 2015 from BYK (Germany).

The white inkjet ink can also include a polymeric binder. In some examples, the polymeric binder is a polyurethane-based binder selected from the group consisting of a polyester-polyurethane binder, a polyether-polyurethane binder, a polycarbonate-polyurethane binder, and combinations thereof.

In an example, the white inkjet ink includes the polyester-polyurethane binder. In an example, the polyester-polyurethane binder is a sulfonated polyester-polyurethane binder. The sulfonated polyester-polyurethane binder can include diaminesulfonate groups. In an example, the polyurethane-based binder is the polyester-polyurethane binder, the polyester-polyurethane binder is a sulfonated polyester-polyurethane binder, and is one of: i) an aliphatic compound including multiple saturated C4 to C10 carbon chains and/or an alicyclic carbon moiety, that is devoid of an aromatic moiety, or ii) an aromatic compound including an aromatic moiety and multiple saturated carbon chain portions ranging from C4 to C10 in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C2 to C10, C3 to C9, or C3 to C6 alkyl. The sulfonated polyester-polyurethane binder can also contain alicyclic carbon moiety. These polyester-polyurethane binders can be described as “aliphatic” because these carbon chains are saturated and because they are devoid of aromatic moieties. An example of a commercially available anionic aliphatic polyester-polyurethane binder that can be used is IMPRANIL® DLN-SD (CAS# 375390-41-3; Mw 133,000; Acid Number 5.2; Tg −47° C.; Melting Point 175-200° C.) from Covestro. Example components used to prepare the IMPRANIL® DLN-SD or other anionic aliphatic polyester-polyurethane binders suitable for the examples disclosed herein can include pentyl glycols, e.g., neopentyl glycol; C4 to C10 alkyldiol, e.g., hexane-1,6-diol; C4 to C10 alkyl dicarboxylic acids, e.g., adipic acid; C4-C10 alkyldiamine, e.g., (2, 4, 4)-trimethylhexane-1,6-diamine (TMD), isophorone diamine (IPD); C4 to C10 alkyl diisocyanates, e.g., hexamethylene diisocyanate (HDI), (2, 4, 4)-trimethylhexane-1,6-diisocyanate (TMDI); alicyclic diisocyanates, e.g. isophorone diisocyanate (IPDI), 1,3-bis(isocyanatomethyl)cyclohexane (H6XDI); diamine sulfonic acids, e.g., 2-[(2-aminoethyl)amino]ethanesulfonic acid; etc.

Alternatively, the sulfonated polyester-polyurethane binder can be aromatic (or include a commercially available aromatic moiety) and can include aliphatic chains. An example of an aromatic polyester-polyurethane binder that can be used is DISPERCOLL® U42 (CAS# 157352-07-3). Example components used to prepare the DISPERCOLL® U42 or other similar aromatic polyester-polyurethane binders can include aromatic dicarboxylic acids, e.g., phthalic acid; C4 to C10 alkyl dialcohols, e.g., hexane-1,6-diol; C4 to C10 alkyl diisocyanates, e.g., hexamethylene diisocyanate (HDI); diamine sulfonic acids, e.g., 2-[(2-aminoethyl)amino]ethanesulfonic acid; etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight (Mw, g/mol or Daltons) ranging from about 20,000 to about 1,000,000. In some examples of the white inkjet ink, the polyurethane-based binder is the polyester-polyurethane binder, and the polyester-polyurethane binder has a weight average molecular weight ranging from about 20,000 Mw to about 300,000 Mw. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the inkjet ink, the polyurethane-based binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g. For this binder, the term “acid number” refers to the mass of potassium hydroxide (KOH) in milligrams that is used to neutralize one gram of the polyester-polyurethane binder.

To determine this acid number, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride), e.g., PolyDADMAC.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data, e.g., volume weighted mean diameter, generated by the NANOTRAC® Wave device.

Other examples of the white inkjet ink include a polyether-polyurethane binder. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the white inkjet ink include a polycarbonate-polyurethane binder. Examples of polycarbonate-polyurethanes that may be used as the polyurethane-based binder include IMPRAN IL® DLC-F or IMPRAN IL® DL 2077 (Covestro (Germany)); or HYDRAN® WLS-213 (DIC Corp. (Japan)); or TAKELAC® W-6110 (Mitsui (Japan)).

In some examples, the polymeric binder of the white ink composition can be reactive with the cationic polymer in the fixer composition. When the white ink composition and the fixer composition are printed together, the cationic polymer of the fixer composition can crosslink with the polymeric binder of the white ink composition. In certain examples, this cross-linking can occur with a polyester polyurethane binder in the white ink composition. The substrate can be heated after applying the white ink composition and the fixer composition to dry and cure these compositions. The heating can help form cross-linking in some examples. The substrate can be heated to a temperature from 80° C. to 200° C. for colored fabric with 100% cotton after applying the white ink composition and fixer composition, in some examples. In further examples, the substrate can be heated to a temperature from 90° to 150° C. or from 100° C. to 120° C. For colored polyester substrates, the drying and curing temperature can be from 80° to 120° C. to minimize dye migration.

The pH of the white ink composition can be adjusted to be suitable for jetting and for maintaining the dispersion of white pigment. In some examples, suitable pH ranges for the white ink composition can be from pH 7 to pH 11, from pH 7 to pH 10, from pH 7.2 to pH 10, from pH 7.5 to pH 10, from pH 8 to pH 10, from pH 7 to pH 9, from pH 7.2 to pH 9, from pH 7.5 to pH 9, from pH 8 to pH 9, from pH 7 to pH 8.5, from pH 7.2 to pH 8.5, from pH 7.5 to pH 8.5, from pH 8 to pH 8.5, from pH 7 to pH 8, from pH 7.2 to pH 8, or from pH 7.5 to pH 8.

### Methods of Textile Printing

The present disclosure also describes methods of textile printing using the fluid sets described above. In some examples, the pretreat composition described above can be applied to a fabric substrate and then the fixer composition and white ink composition described above can be applied after the pretreat composition. In certain examples, the methods can include heating the fabric substrate after applying the pretreat composition and/or after applying the fixer and white ink compositions. White images and patterns printed using these methods can have good washfastness and good opacity.

FIG. 2 is a flowchart illustrating an example method of textile printing 200. The method can include applying 210 a pretreat composition onto a fabric substrate, wherein the pretreat composition includes water and an emulsion of a silicone polymer having amino groups, and the method can further include heat pressing 220 the fabric substrate with the pretreat composition applied thereon. The method can further include ejecting 230 a fixer composition onto the fabric substrate, wherein the fixer composition includes a liquid vehicle and a cationic polymer, ejecting 240 a white ink composition onto the fabric substrate to form a white image, wherein the white ink composition includes a liquid vehicle, a white pigment dispersion, and a polymeric binder, and drying and curing 250 the white image by heating the fabric substrate.

The pretreat composition can be applied by a digital method or an analog method, as mentioned above. In certain examples, the pretreat composition can be applied by spraying. Other analog coating methods can also be used, such as padding, gravure coating, roll coating, wire rod coating, and so on. In other examples, a digital method, such as inkjet printing, can be used to apply the pretreat composition. The pretreat composition can be printed using similar or identical inkjet print heads used to print the white ink composition and the fixer composition. The pretreat composition can also be printed using a piezo print head or a valve jet print head.

As mentioned above, in some examples heating the fabric substrate can be accomplished by heat pressing. Other heating methods can also be used, including the use of a drying oven, infrared heaters, hot air, heated rollers, or others. In some examples, the fabric substrate can be heated after applying the pretreat composition to dry and/or cure the pretreat composition. For example, the fabric can be heat pressed after applying the pretreat composition and before applying the fixer composition and the white ink composition. In certain examples, the heat pressing can be performed at a temperature from 80° C. to 180° C., or from 100° C. to 150° C., or from 100° C. to 120° C. The heating can be performed for a time period from 10 seconds to 180 seconds, or from 30 seconds to 120 seconds, or from 60 seconds to 90 seconds. In further examples, the fabric can be heated a second time after the fixer composition and white ink composition are applied. This heating can be accomplished by heat pressing or by another heating method. In certain examples, the fabric can be heated to a temperature from 80° C. to 200° C. after the fixer and white ink composition are applied. In other examples, the fabric can be heated to a temperature from 100° C. to 180° C., or from 100° C. to 150° C., or from 90° C. to 120° C., or from 90° C. to 110° C. Depending on the method used to heat the fabric substrate, the heating can be performed for a time period from 30 seconds to 12 minutes, or from 30 seconds to 3 minutes, or from 30 seconds to 1 minute, or from 1 minute to 2 minutes, or from 8 minutes to 12 minutes, or from 10 minutes to 12 minutes. In certain examples, heat pressing can be performed for a time from 30 seconds to 3 minutes. In other examples, heat can be applied with an oven for a time from 3 minutes to 12 minutes or from 10 minutes to 12 minutes.

The fixer composition and white ink composition can be applied after heating the fabric to dry and cure the pretreat composition. In some examples, the fixer composition can be applied before the white ink composition. In other examples, the fixer composition and white ink composition can be applied concurrently. These compositions can be applied by inkjet printing. The relative amounts of fixer composition and white ink composition can vary, and can depend on the concentration of ingredients in the compositions. In some examples, the weight ratio of fixer composition to white ink composition that is applied can be from 1:10 to 10:1, or from 1:8 to 1:1, or from 1:6 to 1:2.

The fabric substrate can be any desired type of fabric. In certain examples, the fabric can be a dyed polyester fabric. The fluid sets described herein can be particularly useful for preventing dye migration from dyed polyester fabrics into the white ink when cured at a low temperature. The polyester fabric can be dyed any color, including black, red, navy, green or any other color. However, the fluid sets described herein can also be used successfully on many other types of fabric besides polyester and cotton fabrics. Examples of fabric substrates include various fabrics of natural and/or synthetic fibers. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, spandex fabrics, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable to apply ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials commonly referred to as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

As previously mentioned, the fabric substrate can be a combination of fiber types, e.g. a combination of natural fiber with another natural fiber, natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber, e.g., cotton/polyester blend. The amount of individual fiber types can vary. For example, the amount of the natural fiber can vary from 5 wt % to 94.5 wt % and the amount of the synthetic fiber can range from 5 wt % to 94.5 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of the synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blends thereof, treated, untreated, etc., the fabric substrates printed with the fluid sets of the present disclosure can provide good opacity and/or washfastness properties. The term “washfastness” can be defined as the opacity that is retained or delta E (ΔE) after five (5) standard washing machine cycles using warm water and a standard clothing detergent, e.g., TIDE® available from Proctor and Gamble, Cincinnati, Ohio, USA. By measuring L*a*b* both before and after washing, ΔL* and ΔE value can be determined, which is a quantitative way of expressing the difference between the L*and/or L*a*b* prior to and after undergoing the washing cycles. Thus, the lower the ΔOD and ΔE values, the better. In further detail, ΔE is a single number that represents the “distance” between two colors, which in accordance with the present disclosure, is the white color of the ink prior to washing and the modified color after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (RT) to deal with the blue region at hue angles of about)275°, ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} is used.

### Textile Printing Systems

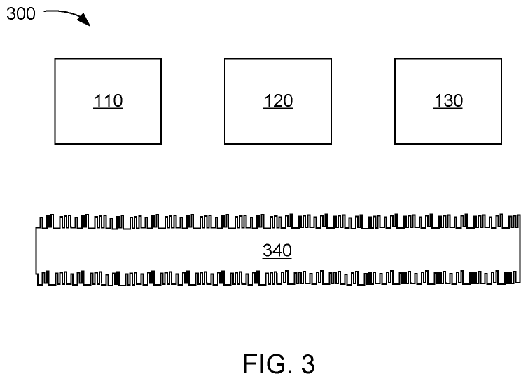

The present disclosure also describes textile printing systems that can print on fabric substrates using the fluid sets described above. The system can include the fabric substrate and the pretreat composition, fixer composition, and white ink composition as described above. FIG. 3 shows an example textile printing system 300 that includes a fabric substrate 340, a pretreat composition 110 to be applied to the fabric substrate, a fixer composition 120 to be applied to the fabric substrate, and a white ink composition 130 to be applied to the fabric substrate. The pretreat composition includes water and an emulsion of a silicone polymer having amino groups. The fixer composition includes a liquid vehicle and a cationic polymer. The white ink composition includes a liquid vehicle, a white pigment dispersion, and a polymeric binder.

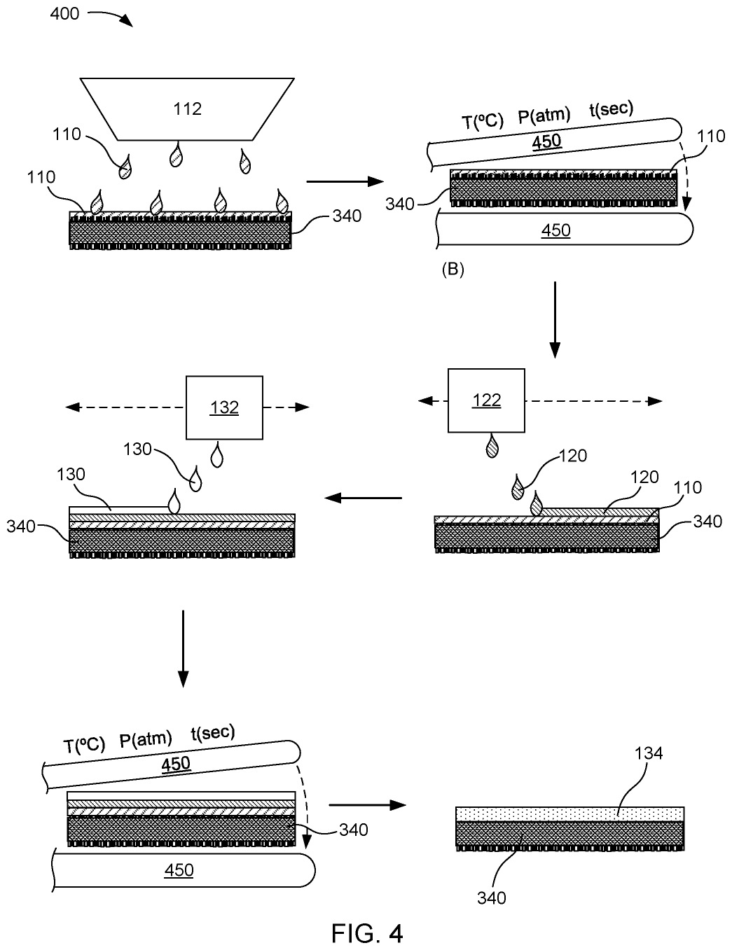

FIG. 4 shows another example of a textile printing system 400. This figure shows the textile printing system divided into multiple zones, where various operations of a textile printing method can be carried out. This system includes a pretreat composition applicator 112 applying a pretreat composition 110 to a fabric substrate 340. In this example, the pretreat composition applicator is a sprayer, but in other examples the pretreat applicator can include an inkjet printhead or another type of coating mechanism. The system also includes a heat press 450 that can be used to heat the fabric substrate. The heat press is shown heating and applying pressure to the fabric substrate after a coating of the pretreat composition has been applied. After the heat pressing, a layer of fixer composition 120 is applied by a fixer composition applicator 122. In this case, the fixer composition applicator is an inkjet printhead. A layer of white ink composition 130 is then applied by a white ink composition applicator 132. The white ink composition applicator is also an inkjet printhead in this example. The heat press is then used again to apply heat and pressure to the fabric substrate. The final result in this system is the fabric substrate having a dried and cured white image 134 on the surface of the fabric substrate.

In further examples, textile printing systems can include different arrangements of components to perform the various operations of textile printing described herein. Accordingly, textile printing systems may not include all the same zones or components in the same order as in the example shown in FIG. 4.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, but also include individual numerical values or sub-ranges encompassed within that range as if the numerical values and sub-range is explicitly recited. For example, a weight ratio range of 1 wt % to 20 wt % should be interpreted to include explicitly recited limits of 1 wt % and 20 wt %, as well as individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are examples or illustrative of the application of the principles of the presented formulations and methods. Numerous modifications and alternative methods may be devised without departing from the present disclosure. The appended claims are intended to cover such modifications and arrangements. Thus, while the technology has been described above with particularity, the following provides further detail in connection with what are presently deemed to be the acceptable examples.

### Example 1

### Fluid Set Compositions

Example fluid sets were prepared, including a pretreat composition, a fixer composition, and a white ink composition. Three different example pretreat compositions were prepared. The first example pretreat composition included 6 wt % (solids) of WACKER® HC 303 silicone emulsion in water. The second example pretreat composition included 6 wt % (solids) of ICM EM 1616 silicone emulsion in water. The third example pretreat composition included 4 wt % (solids) of the ICM EM 1616 silicone emulsion in a liquid vehicle for inkjet printing. A single example fixer composition formulation was used. The ingredients of the fixer composition are shown in Table 1 below. Similarly, a single example white ink composition formulation was used. The ingredients of the white ink composition are shown in Table 2 below.

TABLE 1
Fixer Composition

| Ingredient | Concentration (wt %) |
|---|---|
| 2,2-Dimethyl-1,3-propanediol | 4 |
| CRODAFOS ® N10A | 0.5 |
| SURFYNOL ® 440 | 0.3 |
| POLYCUP ™ 7360A | 4 |
| Water | Balance |

TABLE 2
White Ink Composition

| Ingredient | Concentration (wt %) |
|---|---|
| 1,3-propanediol | 12 |
| LEG-1 | 2 |
| Boehmite | 0.3 |
| ACTICIDE ® B20 (as is) | 0.2 |
| SURFYNOL ® 440 | 0.3 |
| White pigment dispersion | 10 |
| Polyester polyurethane | 10 |
| Water | Balance |

In the above formulations, CRODAFOS® N10A is surfactant available from Croda International PLC, United Kingdom. SURFYNOL® 440 is a surfactant available from Evonik, Germany. POLYCUP™ 7360A is a cationic polymer available from Solenis, USA. DOWANOL™ TPM is an organic co-solvent available from Dow Chemical, USA. ACTICIDE® B20 is a biocide available from Thor Specialties, USA. LEG-1 is an organic co-solvent.

The example fluid sets included the example fixer composition, the example white ink composition, and one of the three example pretreat compositions.

### Example 2

### Washfastness with Example Fluid Sets

The example fluid sets were used to print white ink onto fabric substrate samples. The fabric substrate used in these examples was black dyed polyester fabric. Multiple tests were performed with varying amounts of the fluids and varying heating temperatures and times. After printing the white ink onto the fabric, the L*a*b* color values were measured. The fabric was then washed 5 times, and the L*a*b* color values were measured again.

The printed fabric substrates were washed in a standard washing machine typically used to wash clothing, namely the WHIRLPOOL® WTW5000DW, with detergent. The washing machine settings were set as follows: Soil level “medium,” temperature “warm,” e.g., about 40° C., and wash setting “normal” with a single rinse cycle. The full washing machine cycle was repeated for 5 full washes, air drying the printed fabric substrates between wash cycles. After the five fully washing cycles, the L*a*b* values were again measured for comparison. The delta E (ΔE) values were calculated using the 1976 standard denoted as ΔE_{CIE}.

Table 3 shows the fluids and temperatures used in the examples. Table 4 shows the washfastness data for the examples.

TABLE 3
Example Printed Black Polyester Fabric Substrates

| | | | | Heat |
|---|---|---|---|---|
| | Pretreat | Example | Amount of | Treatment |
| Example | Application | Pretreat | Pretreat | after |
| ID | Method | Composition | (gsm) | Pretreat |
| Example 1 | Spray | 6% WACKER ® | 58.8 | Heat Press |
| | | HC 303 | | 100° C. |
| | | | | for 2 mins |
| Example 2 | Spray | 6% WACKER ® | 93.5 | Heat Press |
| | | HC 303 | | 100° C. |
| | | | | for 2 mins |
| Example 3 | Spray | 6% WACKER ® | 130.5 | Heat Press |
| | | HC 303 | | 100° C. |
| | | | | for 2 mins |
| Example 4 | Spray | 6% ICM EM | 59.3 | Heat Press |
| | | 1616 | | 150° C. |
| | | | | for 30 s |
| Example 5 | Inkjet | 4% ICM EM | 200 | Heat Press |
| | | 1616 in inkjet | | 150° C. |
| | | vehicle | | for 30 s |
| Comp. | None | None | None | None |
| Example 1 | | | | |
| Comp. | None | None | None | None |
| Example 2 | | | | |
| Comp. | None | None | None | None |
| Example 3 | | | | |
| Comp. | Spray | 6% ICM EM | 64.9 | Heat Press |
| Example 4 | | 1616 | | 150° C. |
| | | | | for 30 s |
| Example 6 | Spray | 6% ICM EM | 59.3 | Heat Press |
| | | 1616 | | 150° C. |
| | | | | for 30 s |
| Example 7 | Inkjet | 4% ICM EM | 50 | Heat Press |
| | | 1616 in inkjet | | 150° C. |
| | | vehicle | | for 30 s |
| Example 8 | Inkjet | 4% ICM EM | 100 | Heat Press |
| | | 1616 in inkjet | | 150° C. |
| | | vehicle | | for 30 s |
| Example 9 | Inkjet | 4% ICM EM | 200 | Heat Press |
| | | 1616 in inkjet | | 150° C. |
| | | vehicle | | for 30 s |
| Comp. | None | None | None | None |
| Example 5 | | | | |
| Comp. | None | None | None | None |
| Example 6 | | | | |
| Comp. | None | None | None | None |
| Example 7 | | | | |
| Comp. | Spray | 6% ICM EM | 64.9 | Heat Press |
| Example 8 | | 1616 | | 150° C. |
| | | | | for 30 s |

TABLE 4
White printing and Washfastness Data

| | | | Heat | | |
|---|---|---|---|---|---|
| | Fixer | White Ink | Treatment | L* | |
| Example | Density | Density | after | before | ΔE after |
| ID | (gsm) | (gsm) | Printing | Wash | 5 Washes |
| Example 1 | 55 | 295 | Oven 100° C. | 87.0 | 1.09 |
| | | | for 12 min | | |
| Example 2 | 55 | 295 | Oven 100° C. | 88.5 | 0.85 |
| | | | for 12 min | | |
| Example 3 | 55 | 295 | Oven 100° C. | 87.5 | 1.38 |
| | | | for 10 min | | |
| Example 4 | 55 | 295 | Oven 100° C. | 89.8 | 0.23 |
| | | | for 10 min | | |
| Example 5 | 55 | 295 | Oven 100° C. | 90.3 | 0.18 |
| | | | for 10 min | | |
| Comp. | 55 | 295 | Oven 100° C. | 79.1 | 1.32 |
| Example 1 | | | for 12 min | | |
| Comp. | 55 | 295 | Oven 100° C. | 79.3 | 0.69 |
| Example 2 | | | for 10 min | | |
| Comp. | 55 | 295 | Heat Press | 55.9 | 8.72 |
| Example 3 | | | 150° C. for | | |
| | | | 3 min | | |
| Comp. | 55 | 295 | Heat Press | 70.3 | 2.59 |
| Example 4 | | | 150° C. for | | |
| | | | 3 min | | |
| Example 6 | 74 | 393 | Oven 100° C. | 92.1 | 0.80 |
| | | | for 10 min | | |
| Example 7 | 74 | 393 | Oven 100° C. | 92.0 | 0.54 |
| | | | for 10 min | | |
| Example 8 | 74 | 393 | Oven 100° C. | 91.9 | 0.44 |
| | | | for 10 min | | |
| Example 9 | 74 | 393 | Oven 100° C. | 91.7 | 0.59 |
| | | | for 10 min | | |
| Comp. | 74 | 393 | Oven 100° C. | 87.1 | 0.34 |
| Example 5 | | | for 12 min | | |
| Comp. | 74 | 393 | Oven 100° C. | 87.6 | 0.47 |
| Example 6 | | | for 10 min | | |
| Comp. | 74 | 393 | Heat Press | 60.9 | 11.15 |
| Example 7 | | | 150° C. for | | |
| | | | 3 min | | |
| Comp. | 74 | 393 | Heat Press | 78.3 | 0.76 |
| Example 8 | | | 150° C. for | | |
| | | | 3 min | | |

The experimental results suggest that applying the pretreat composition and curing the white ink composition at a relatively lower temperature can both contribute to higher L* values. The comparative examples that did not include any pretreat composition had low L* values, because the white ink penetrated more into the fabric. The comparative examples in which the white ink composition was cured at a temperature of 150° C. also had lower L* values compared to the examples in which the white ink composition was cured at 100° C., due to the dye migration at a high temperature.

### Example 3

### Testing on Black Dyed Cotton Fabric

A similar set of tests were performed using black dyed cotton as the fabric substrate. The dye in cotton fabric can be more tightly bonded to the fibers compared to polyester fabric. Therefore, there is no dye migration on black cotton fabric. Table 5 shows the pretreat compositions and heat treatments used for the examples tested on the black cotton fabric. Table 6 shows the amounts of fixer composition and white ink composition, the heat treatment used after printing, the L* value before washing and the ΔE value after 5 wash cycles.

TABLE 5
Example Printed Black Cotton Fabric Substrates

| | | | | Heat |
|---|---|---|---|---|
| | Pretreat | Example | Amount of | Treatment |
| Example | Application | Pretreat | Pretreat | after |
| ID | Method | Composition | (gsm) | Pretreat |
| Example 10 | Spray | 6% WACKER ® | 50.2 | Heat Press |
| | | HC 303 | | 150° C. for |
| | | | | 60 s |
| Example 11 | Spray | 6% WACKER ® | 92.4 | Heat Press |
| | | HC 303 | | 150° C. for |
| | | | | 60 s |
| Example 12 | Spray | 6% WACKER ® | 112 | Heat Press |
| | | HC 303 | | 150° C. for |
| | | | | 60 s |
| Example 13 | Spray | 6% ICM EM | 80.3 | Heat Press |
| | | 1616 | | 150° C. for |
| | | | | 60 s |
| Example 14 | Inkjet | 4% ICM EM | 50 | Heat Press |
| | | 1616 in inkjet | | 150° C. for |
| | | vehicle | | 40 s |
| Example 15 | Inkjet | 4% ICM EM | 200 | Heat Press |
| | | 1616 in inkjet | | 150° C. for |
| | | vehicle | | 60 s |
| Comp. | None | None | None | None |
| Example 9 | | | | |
| Example 16 | Spray | 6% WACKER ® | 115 | Heat Press |
| | | HC 303 | | 150° C. for |
| | | | | 60 s |
| Example 17 | Spray | 6% ICM EM | 80.3 | Heat Press |
| | | 1616 | | 150° C. for |
| | | | | 60 s |
| Example 18 | Inkjet | 4% ICM EM | 100 | Heat Press |
| | | 1616 in inkjet | | 150° C. for |
| | | vehicle | | 60 s |
| Comp. | None | None | None | None |
| Example 10 | | | | |

TABLE 6
Washfastness Data

| | Fixer | White Ink | Heat | | |
|---|---|---|---|---|---|
| | Density | Density | Treatment | L* | |
| Example | (drops per | (drops per | after | before | ΔE after |
| ID | pixel) | pixel) | Printing | Wash | 5 Washes |
| Example 10 | 55 | 295 | Heat Press | 92.8 | 0.33 |
| | | | 150° C. for | | |
| | | | 3 min | | |
| Example 11 | 55 | 295 | Heat Press | 94.1 | 0.33 |
| | | | 150° C. for | | |
| | | | 3 min | | |
| Example 12 | 55 | 295 | Heat Press | 94.6 | 0.58 |
| | | | 150° C. for | | |
| | | | 3 min | | |
| Example 13 | 55 | 295 | Heat Press | 92.2 | 0.94 |
| | | | 150° C. for | | |
| | | | 3 min | | |
| Example 14 | 55 | 295 | Heat Press | 92.9 | 0.31 |
| | | | 150° C. for | | |
| | | | 3 min | | |
| Example 15 | 55 | 295 | Heat Press | 92.6 | 0.26 |
| | | | 150° C. for | | |
| | | | 3 min | | |
| Comp. | 55 | 295 | Heat Press | 83.4 | 0.38 |
| Example 9 | | | 150° C. for | | |
| | | | 3 min | | |
| Example 16 | 74 | 393 | Heat Press | 96.0 | 0.34 |
| | | | 150° C. for | | |
| | | | 3 min | | |
| Example 17 | 74 | 393 | Heat Press | 95.5 | 0.74 |
| | | | 150° C. for | | |
| | | | 3 min | | |
| Example 18 | 74 | 393 | Heat Press | 95.3 | 0.46 |
| | | | 150° C. for | | |
| | | | 3 min | | |
| Comp. | 74 | 393 | Heat Press | 92.8 | 0.98 |
| Example 10 | | | 150° C. for | | |
| | | | 3 min | | |

These results suggest that the presence of the pretreat composition helps to increase the L* value of the white ink on black cotton fabric. Additionally, curing the white ink at 150° C. or above is feasible when the fabric substrate is cotton instead of dark polyester because there is no dye migration on cotton.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A fluid set for printing, comprising:
a pretreat composition comprising water and an emulsion of a silicone polymer having amino groups;
a fixer composition comprising a liquid vehicle and a cationic polymer; and
a white ink composition comprising a liquid vehicle, a white pigment dispersion, and a polymeric binder.

2. The fluid set of claim 1, wherein the silicone polymer includes a hydroxyl group or a methoxy group attached to a terminal silicon atom of the silicone polymer.

3. The fluid set of claim 2, wherein the silicone polymer further includes a plurality of methyl groups attached to silicon atoms of the silicone polymer, wherein some of the methyl groups are substituted by C1-C6 aminoalkyl radicals.

4. The fluid set of claim 3, wherein the aminoalkyl radicals include an N-(2-aminoethyl)-3-aminopropyl radical, an aminopropyl radical, or a combination thereof.

5. The fluid set of claim 1, wherein the emulsion of the silicone polymer has an average particle size from 1 nm to 50 nm.

6. The fluid set of claim 1, wherein the pretreat composition includes the silicone polymer in an amount from 1 wt % to 15 wt %.

7. The fluid set of claim 1, wherein the cationic polymer is curable by forming crosslinking at a curing temperature from 80° C. to 200° C.

8. The fluid set of claim 1, wherein the white pigment dispersion comprises titanium dioxide, zinc oxide, zinc sulfide, antimony oxide, zirconium dioxide, alumina hydrate, or a combination thereof.

9. The fluid set of claim 1, wherein the polymeric binder comprises a polyester polyurethane or an acrylic latex binder.

10. A method of textile printing, comprising:
applying a pretreat composition onto a fabric substrate, wherein the pretreat composition comprises water and an emulsion of a silicone polymer having amino groups;
heat pressing the fabric substrate with the pretreat composition applied thereon;
ejecting a fixer composition onto the fabric substrate, wherein the fixer composition comprises a liquid vehicle and a cationic polymer;
ejecting a white ink composition onto the fabric substrate, wherein the white ink composition comprises a liquid vehicle, a white pigment dispersion, and a polymeric binder; and
curing the fixer composition and the white ink composition by heating the fabric substrate.

11. The method of claim 9, wherein the curing is performed at a temperature from 80° C. to 200° C.

12. The method of claim 9, wherein the pretreat composition is applied by spraying or by ejecting from jetting architecture.

13. A textile printing system, comprising:
a fabric substrate;
a pretreat composition to be applied to the fabric substrate, the pretreat composition comprising water and an emulsion of a silicone polymer having amino groups;
a fixer composition to be applied to the fabric substrate, the fixer composition comprising a liquid vehicle and a cationic polymer; and
a white ink composition to be applied to the fabric substrate, the white ink composition comprising a liquid vehicle, a white pigment dispersion, and a polymeric binder.

14. The textile printing system of claim 13, wherein the silicone polymer includes a hydroxyl group or a methoxy group attached to a terminal silicon atom of the silicone polymer and a plurality of methyl groups attached to silicon atoms of the silicone polymer, wherein some of the methyl groups are substituted by C1-C6 aminoalkyl radicals.

15. The textile printing system of claim 14, wherein the aminoalkyl radicals include an N-(2-aminoethyl)-3-aminopropyl radical, an aminopropyl radical, or a combination thereof.
